(19) United States
(12) Patent Application Publication
(10) Pub. No.: US 2026/0201838 A1
(43) Pub. Date: Jul. 16, 2026

(54) RUST PREVENTION METHOD FOR GAS TURBINE AND GAS TURBINE EQUIPMENT CAPABLE OF EXECUTING SAME

(71) Applicant: MITSUBISHI HEAVY INDUSTRIES, LTD., Tokyo (JP)

(72) Inventors: Masato ARAKI, Tokyo (JP); Takashi SHIRAIWA, Tokyo (JP); Ayumu KUROSHIMA, Tokyo (JP)

(21) Appl. No.: 19/137,823

(22) PCT Filed: Dec. 13, 2023
(86) PCT No.: PCT/JP2023/044617

§ 371 Date: Jun. 11, 2025

(30) Foreign Application Priority Data
Dec. 21, 2022 (JP) 2022-204295

(51) Int. Cl. F02C 7/30

(52) U.S. Cl. CPC F02C 7/30; F05D 2260/95

(57) ABSTRACT

Gas turbine equipment according to the present invention comprises a gas turbine and a drying air system. The drying air system has an air line down which air from an air supply source can flow. The drying air system is configured such that air that has flowed down the air line can be supplied into an intake casing of the gas turbine as drying air.

### TECHNICAL FIELD

The present disclosure relates to a rust prevention method for a gas turbine and gas turbine equipment capable of executing the method.

Priority is claimed on Japanese Patent Application No. 2022-204295 filed on Dec. 21, 2022, the content of which is incorporated herein by reference.

### BACKGROUND ART

A gas turbine includes a compressor that can compress air to generate compressed air, a combustor that can combust fuel in the compressed air to generate a combustion gas, a turbine that can be driven by the combustion gas, an intake casing, and an intermediate casing.

The compressor includes a compressor rotor that is rotatable around an axis, and a compressor casing that covers the compressor rotor. The turbine is disposed on the axial downstream side with respect to the compressor. This turbine has a turbine rotor that is connected to a compressor rotor and is rotatable around an axis, and a turbine casing that covers the turbine rotor.

The intake casing is connected to an end of the compressor casing on the axial upstream side such that air is guided into the compressor casing. The intermediate casing is disposed between the compressor casing and the turbine casing in the axial direction. The combustor is attached to the intermediate casing so that the compressed air discharged from the compressor into the intermediate casing can flow in.

The following PTL 1 discloses gas turbine equipment including the gas turbine described above, the cooling air system, and the dry air system.

The cooling air system can supply cooling air to the turbine rotor exposed to the combustion gas during the operation of the gas turbine. The dry air system can supply the dry air to the cooling air system during the operation stop of the gas turbine.

In the gas turbine equipment described in PTL 1, during the operation stop of the gas turbine, the supply of the dry air to the cooling air system makes it possible to suppress the occurrence of rust in the air pipe constituting a part of the cooling air system.

### CITATION LIST

### Patent Literature

[PTL 1] Japanese Unexamined Patent Application Publication No. 2015-140691

### SUMMARY OF INVENTION

### Technical Problem

When a gas turbine is kept in an operation stop state for a long period of time, rust may be generated in the gas turbine. For this reason, there is a demand in the field of gas turbines to suppress the occurrence of rust in the gas turbine.

Therefore, an object of the present disclosure is to provide a rust prevention method for a gas turbine capable of suppressing the occurrence of rust in the gas turbine, and gas turbine equipment capable of executing the method.

### Solution to Problem

According to one aspect for achieving the above object, there is provided gas turbine equipment including: a gas turbine; and a dry air system capable of supplying dry air into the gas turbine.

The gas turbine includes a compressor capable of compressing air to generate compressed air, a combustor capable of combusting fuel in the compressed air to generate a combustion gas, a turbine capable of being driven by the combustion gas, an intake casing, and an intermediate casing. The compressor includes a compressor rotor rotatable around an axis, and a compressor casing that covers the compressor rotor. The turbine is disposed on an axial downstream side out of an axial upstream side and the axial downstream side in an axial direction in which the axis extends with respect to the compressor. The turbine includes a turbine rotor connected to the compressor rotor and rotatable around the axis, and a turbine casing that covers the turbine rotor. The intake casing is connected to an end of the compressor casing on the axial upstream side such that air is guided into the compressor casing. The intermediate casing is disposed between the compressor casing and the turbine casing in the axial direction, is connected to an end of the compressor casing on the axial downstream side such that the compressed air from the compressor is capable of flowing in, and is connected to an end of the turbine casing on the axial upstream side. The combustor is attached to the intermediate casing such that the compressed air in the intermediate casing is capable of flowing into the combustor and the combustion gas is capable of being sent into the turbine casing. The dry air system includes an air line through which air from an air supply source is capable of flowing, and is configured to supply the air flowing through the air line into the intake casing as the dry air.

In the present aspect, during the stop of the gas turbine, the dry air from the dry air system is supplied into the intake casing. Basically, a stack for discharging exhaust gas from the gas turbine is provided on the exhaust side of the gas turbine. For this reason, the air in the gas turbine is drawn to the stack side even in a state where the gas turbine rotor is not rotating, due to the draft effect of the stack. Therefore, the dry air supplied into the intake casing flows into the intermediate casing through the inside of the compressor casing. The dry air that has flowed into the intermediate casing is exhausted from the gas turbine through the combustor and the turbine casing. In this way, the dry air flows over almost the entire gas turbine, and thus the occurrence of rust inside the gas turbine, particularly inside the compressor casing, can be suppressed.

A rust prevention method for a gas turbine as an aspect for achieving the above object is applied to the following gas turbine.

This gas turbine includes a compressor capable of compressing air to generate compressed air, a combustor capable of combusting fuel in the compressed air to generate a combustion gas, a turbine capable of being driven by the combustion gas, an intake casing, and an intermediate casing. The compressor includes a compressor rotor rotatable around an axis, and a compressor casing that covers the compressor rotor. The turbine is disposed on an axial downstream side out of an axial upstream side and the axial downstream side in an axial direction in which the axis extends with respect to the compressor. The turbine includes a turbine rotor connected to the compressor rotor and rotatable around the axis, and a turbine casing that covers the turbine rotor. The intake casing is connected to an end of the compressor casing on the axial upstream side such that air is guided into the compressor casing. The intermediate casing is disposed between the compressor casing and the turbine casing in the axial direction, is connected to an end of the compressor casing on the axial downstream side such that the compressed air from the compressor is capable of flowing in, and is connected to an end of the turbine casing on the axial upstream side. The combustor is attached to the intermediate casing such that the compressed air in the intermediate casing is capable of flowing into the combustor and the combustion gas is capable of being sent into the turbine casing.

In this rust prevention method for a gas turbine, the dry air supply step of supplying dry air into the intake casing is executed during stop of the gas turbine.

In the present aspect, as in the first aspect of the gas turbine equipment, it is possible to suppress the occurrence of rust inside the gas turbine, particularly inside the compressor casing.

### Advantageous Effects of Invention

According to one aspect of the present disclosure, it is possible to suppress the occurrence of rust in the gas turbine.

### BRIEF DESCRIPTION OF DRAWINGS

FIG. 1 is a schematic configuration view of gas turbine equipment in a first embodiment according to the present disclosure.

FIG. 2 is a flowchart showing a procedure for executing the rust prevention method for a gas turbine in the first embodiment according to the present disclosure.

FIG. 3 is a time chart of the rust prevention method for a gas turbine in the first embodiment according to the present disclosure.

FIG. 4 is a time chart of the rust prevention method for a gas turbine in a modification example of the first embodiment according to the present disclosure.

FIG. 5 is a schematic configuration view of gas turbine equipment in a second embodiment according to the present disclosure.

FIG. 6 is a flowchart showing a procedure for executing the rust prevention method for a gas turbine in the second embodiment according to the present disclosure.

### DESCRIPTION OF EMBODIMENTS

Hereinafter, various embodiments of a rust prevention method for a gas turbine and gas turbine equipment capable of executing the method according to the present disclosure will be described with reference to the drawings.

### First Embodiment

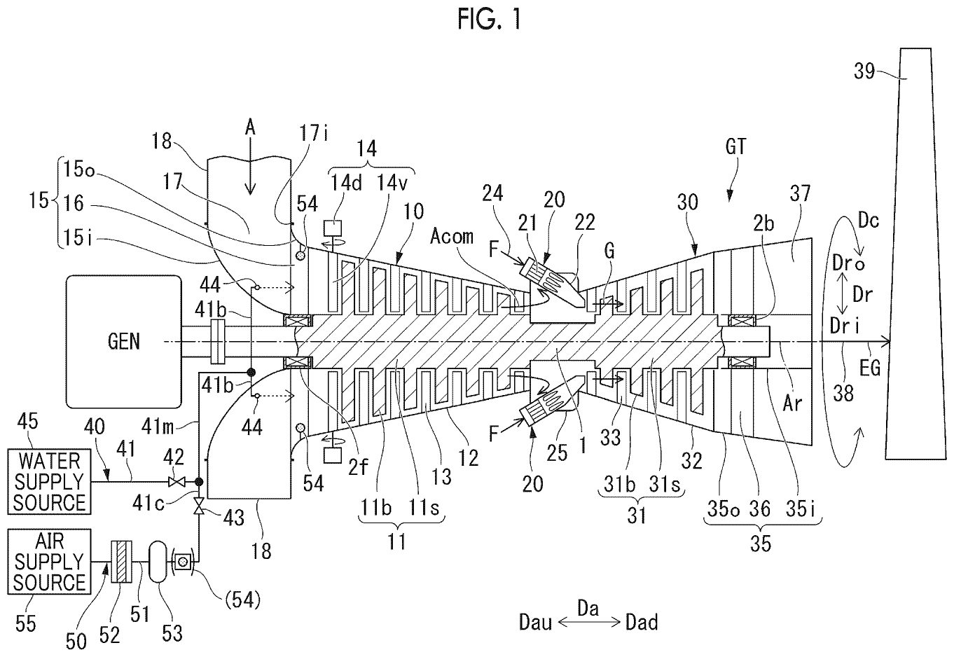

Hereinafter, an embodiment of a rust prevention method for a gas turbine and an embodiment of gas turbine equipment capable of executing the method in the present embodiment will be described with reference to FIGS. 1 to 4.

As shown in FIG. 1, the gas turbine equipment in the present embodiment includes a gas turbine GT, an air intake duct 18, an air exhaust duct 38, a stack 39, a cleaning water system 40 capable of injecting cleaning water into the gas turbine GT, a dry air system 50 capable of supplying dry air into the gas turbine GT, and a plurality of rust inhibitors 54.

The gas turbine GT includes a compressor 10 that is capable of compressing air A to generate compressed air Acom, a plurality of combustors 20 that combust fuel F in the compressed air Acom to generate a combustion gas G, a turbine 30 that is driven by the combustion gas G having a high temperature and a high pressure, an intake casing 15 that is capable of guiding the air A from an air intake duct 18 to the compressor 10, an exhaust casing 35 through which an exhaust gas EG, which is the combustion gas G exhausted from the turbine 30, flows, an intermediate casing 25, a front bearing 2f, and a rear bearing 2b.

The compressor 10 includes a compressor rotor 11 that is rotatable around an axis Ar, a compressor casing 12 that covers the compressor rotor 11, a plurality of compressor stator blade rows 13, and an intake air amount regulator 14. The turbine 30 has a turbine rotor 31 that is rotatable about the axis Ar, a turbine casing 32 that covers the turbine rotor 31, and a plurality of turbine stator blade rows 33. In the following, a direction in which the axis Ar extends will be referred to as an axial direction Da, one side in the axial direction Da will be referred to as an axial upstream side Dau, and the other side in the axial direction Da will be referred to as an axial downstream side Dad. In addition, a circumferential direction around the axis Ar is simply referred to as a circumferential direction Dc. In addition, a direction perpendicular to the axis Ar is a radial direction Dr, a side approaching the axis Ar in the radial direction Dr is a radial inner side Dri, and a side opposite to the radial inner side Dri is a radial outer side Dro.

The compressor 10 is disposed on the axial upstream side Dau with respect to the turbine 30. The compressor rotor 11 has a compressor rotor shaft 11s that extends in the axial direction Da centered on the axis Ar, and a plurality of compressor rotor blade rows 11b attached to the compressor rotor shaft Ils. The plurality of compressor rotor blade rows 11b are arranged in the axial direction Da. Each compressor rotor blade row 11b is configured by a plurality of rotor blades arranged in the circumferential direction De. Any one compressor stator blade row 13 among the plurality of compressor stator blade rows 13 is disposed on each axial downstream side Dad of the plurality of compressor rotor blade rows 11b. Each of the compressor stator blade rows 13 is attached to the inside of the compressor casing 12. Each compressor stator blade row 13 is composed of a plurality of stator blades arranged in the circumferential direction De. The intake air amount regulator 14 includes a plurality of inlet guide blades 14v and a driver 14d capable of changing the direction of each inlet guide blade 14v. The plurality of inlet guide blades 14v are disposed on the axial upstream side Dau with respect to the plurality of compressor rotor blade rows 11b. The plurality of inlet guide blades 14v are disposed side by side in the circumferential direction Dc.

The turbine rotor 31 includes a turbine rotor shaft 31s extending in the axial direction Da centered on the axis Ar, and a plurality of turbine rotor blade rows 31b attached to the turbine rotor shaft 31s. The plurality of turbine rotor blade rows 31b are arranged in the axial direction Da. Each turbine rotor blade row 31b is composed of the plurality of rotor blades arranged in the circumferential direction Dc. Any one turbine stator blade row 33 among the plurality of turbine stator blade rows 33 is disposed on each axial upstream side Dau of the plurality of turbine rotor blade rows 31b. Each turbine stator blade row 33 is attached to the inside of the turbine casing 32. Each turbine stator blade row 33 is composed of the plurality of stator blades arranged in the circumferential direction De.

The intermediate casing 25 is disposed between the compressor casing 12 and the turbine casing 32 in the axial direction Da. An end of the intermediate casing 25 on the axial upstream side Dau is connected to an end of the compressor casing 12 on the axial downstream side Dad. An end of the intermediate casing 25 on the axial downstream side Dad is connected to an end of the turbine casing 32 on the axial upstream side Dau. The plurality of combustors 20 are arranged in a circumferential direction Dc and attached to the intermediate casing 25.

The combustor 20 has a burner 21 capable of injecting the fuel F and the compressed air Acom, and a transition piece (or combustion tube) 22 in which the fuel F injected from the burner 21 can be combusted in the compressed air Acom. A fuel line 24 capable of guiding the fuel F from a fuel supply source to the burner 21 is connected to the burner 21. In the transition piece 22, the fuel F is combusted in the compressed air Acom, and the combustion gas G is generated. The transition piece 22 can guide the combustion gas G into the turbine casing 32.

The intake casing 15 is connected to an end of the compressor casing 12 on the axial upstream side Dau. The intake casing 15 includes an intake inner casing 15i, an intake outer casing 150, and a plurality of intake struts 16. The intake inner casing 15i has a tubular shape around the axis Ar, and covers a portion on the axial upstream side Dau with respect to the inlet guide blade 14v in the compressor rotor shaft 11s. The intake inner casing 15i is formed to gradually face the radial outer side Dro toward the axial upstream side Dau. The intake outer casing 150 has a tubular shape around the axis Ar and is disposed at an interval on the radial outer side Dro with respect to the intake inner casing 15i. An end of the intake outer casing 150 on the axial downstream side Dad is connected to an end of the compressor casing 12 on the axial upstream side Dau. The intake outer casing 150 is also formed to gradually face the radial outer side Dro toward the axial upstream side Dau. A space between the intake inner casing 15i and the intake outer casing 150 in the radial direction Dr forms an air passage 17 that guides air into the compressor casing 12. A intake port 17i is formed between an end of the intake inner casing 15i on the axial upstream side Dau and an end of the intake outer casing 150 on the axial upstream side Dau. The intake port 17i is open toward the radial outer side Dro from inside the air passage 17. The air intake duct 18 is connected to the intake casing 15. The air from the air intake duct 18 flows into the air passage 17 of the intake casing 15 via the intake port 17i of the intake casing 15. The plurality of intake struts 16 are arranged in the circumferential direction De between the intake inner casing 15i and the intake outer casing 150. An end of the intake strut 16 on the radial inner side Dri is connected to the intake inner casing 151. An end of the intake strut 16 on the radial outer side Dro is connected to the intake outer casing 150.

The exhaust casing 35 is connected to an end of the turbine casing 32 on the axial upstream side Dau. The exhaust casing 35 includes an exhaust inner casing 35i, an exhaust outer casing 350, and a plurality of exhaust struts 36. The exhaust inner casing 35i has a tubular shape around the axis Ar, and covers a portion on the axial downstream side Dad with respect to the plurality of turbine rotor blade rows 31b in the turbine rotor shaft 31s. The exhaust outer casing 350 has a tubular shape around the axis Ar, and is disposed at an interval on the radial outer side Dro with respect to the exhaust inner casing 35i. An end of the exhaust outer casing 350 on the axial upstream side Dau is connected to an end of the turbine casing 32 on the axial downstream side Dad. A space between the exhaust inner casing 35i and the exhaust outer casing 350 in the radial direction Dr forms an exhaust passage 37 through which the exhaust gas EG, which is the combustion gas G exhausted from the turbine 30, flows. The plurality of exhaust struts 36 are arranged in the circumferential direction Dc between the exhaust inner casing 35i and the exhaust outer casing 350. An end of the exhaust strut 36 on the radial inner side Dri is connected to the exhaust inner casing 35i. An end of the exhaust strut 36 on the radial outer side Dro is connected to the exhaust outer casing 350.

An air exhaust duct 38 is connected to an end of the exhaust casing 35 on the axial downstream side Dad. A stack 39 is connected to an end of the air exhaust duct 38 on the axial downstream side Dad. The exhaust gas EG from the turbine 30 is exhausted from the stack 39 via the exhaust casing 35 and the air exhaust duct 38. In some cases, a heat recovery steam generator that generates steam by using the heat of the exhaust gas EG is installed in the air exhaust duct 38.

The compressor rotor 11 and the turbine rotor 31 are located on the same axis Ar and are connected to each other to form a gas turbine rotor 1. A rotor of a generator GEN is connected to the gas turbine rotor 1. A portion of the gas turbine rotor 1 on the axial upstream side Dau is supported by the front bearing 2f. A portion of the gas turbine rotor 1 on the axial downstream side Dad is supported by the rear bearing 2b. The front bearing 2f is disposed at a position where the plurality of intake struts 16 are disposed in the axial direction Da. The front bearing 2f is supported by the plurality of intake struts 16 via the intake inner casing 15i. The rear bearing 2b is disposed at a position where the plurality of exhaust struts 36 are disposed in the axial direction Da. Thereafter, the rear bearing 2b is supported by the plurality of exhaust struts 36 via the exhaust inner casing 35i.

The cleaning water system 40 has a cleaning water line 41 that extends from the water supply source 45 to the inside of the intake casing 15, and a plurality of nozzles 44 attached to an end of the cleaning water line 41 in the intake casing 15. The cleaning water line 41 includes a cleaning water main line 41m connected to the water supply source 45, a connection line 41c connected to the cleaning water main line 41m in the middle, a plurality of cleaning water branch lines 41b branched from the cleaning water main line 41m at an end of the cleaning water main line 41m, a water stop valve 42, and an air stop valve 43. Each of the ends of the plurality of cleaning water branch lines 41b is arranged in the intake casing 15 in the circumferential direction Dc. Nozzles 44 capable of injecting the water flowing through the cleaning water line 41 to the axial downstream side Dad are attached to each of the ends of the plurality of cleaning water branch lines 41b. The water stop valve 42 is provided at a position closer to the water supply source 45 than a position where the connection line 41c is connected in the cleaning water main line 41m. The air stop valve 43 is provided at an end of the connection line 41c.

The dry air system 50 includes an air line 51 connected to an air supply source 55, a filter 52 provided in the air line 51, and a dehumidifier 53 provided in the air line 51. The air supply source 55 may be a compressed air tank in which compressed air is stored, or may be a compressor that generates compressed air. The compressed air tank is shared in a plant including the gas turbine GT, for example. In addition, the compressor sucks in outside air and compresses the outside air, for example. The end of the air line 51 is connected to the air stop valve 43 of the cleaning water system 40 before the dry air system 50 is used. The dehumidifier 53 may be any type of dehumidifier as long as it is a device capable of removing moisture in the air from the air supply source 55. As the type of the dehumidifier 53, for example, there is a type that cools air to condense moisture in the air and removes the moisture, and a type that removes the moisture in the air with a dehumidifying agent or a drying agent.

The plurality of rust inhibitors 54 are disposed in the intake casing 15 before the dry air system 50 described above is used. The rust inhibitor 54 is a vaporizable solid material and contains a rust-inhibiting component. For example, the rust inhibitor 54 is put in a mesh bag and is attached to the intake outer casing 150, the intake strut 16, the nozzle 44 of the cleaning water system 40, and the like. Examples of the rust inhibitor 54 include FERRO-gard (registered trademark of USC Co., Ltd.). The rust inhibitor 54 may be a vaporizable liquid. In this case, the liquid rust inhibitor 54 is infiltrated into cotton or the like, and the infiltrated cotton or the like is put into a mesh bag and attached to the intake outer casing 150 described above or the like.

Next, a rust prevention method for the gas turbine GT in the present embodiment will be described.

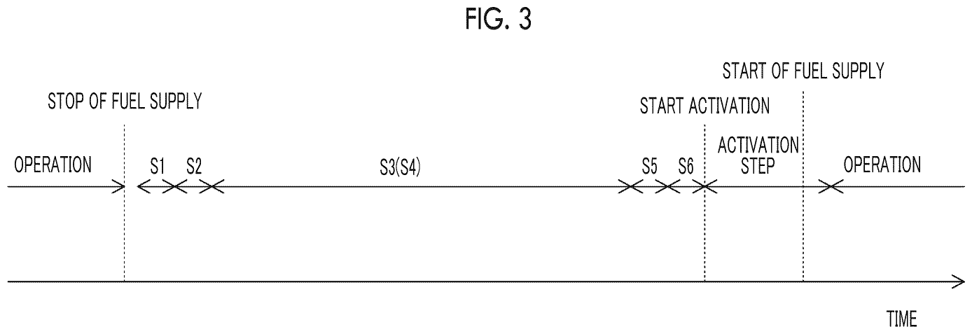

The rust prevention method in the present embodiment is executed during stop of the gas turbine GT. Specifically, as shown in the time chart of FIG. 3, the rust prevention method is executed during the period when the operation of the gas turbine GT is stopped after the fuel supply to the gas turbine GT is stopped, and the operation is executed until the start of the activation of the gas turbine GT. The stop of the gas turbine GT includes not only a case where the gas turbine rotor 1 is not rotating at all but also a case where the gas turbine GT is turning. In this case, the air in the compressor casing 12, the intermediate casing 25, and the turbine casing 32 is stirred by the gas turbine rotor 1. Therefore, the air density, the air humidity, and the like in each of the casings 12, 25, and 32 are substantially uniform. The turning is to rotate the gas turbine rotor 1 at 5 rpm or less in order to suppress the deformation of the gas turbine rotor 1.

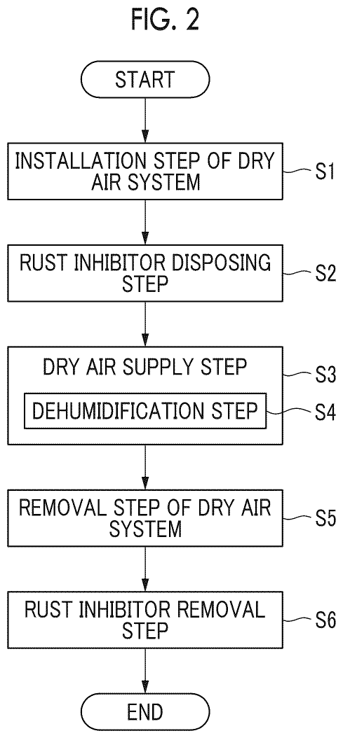

When the gas turbine GT is stopped, the dry air system 50 is installed as shown in the flowchart of FIG. 2 (installation step SI of the dry air system 50). In this case, the dry air system 50 prepared in advance is disposed near the intake casing 15, and the end of the air line 51 of the dry air system 50 is connected to the air stop valve 43 of the cleaning water system 40. In addition, a connection flange may be provided at an end of the air line 51 of the dry air system 50, and a connection flange may be provided at an end of the connection line 41c of the cleaning water system 40, and both flanges may be connected to each other to connect the dry air system 50 and the cleaning water system 40.

Next, the rust inhibitor 54 is disposed in the intake casing 15 (rust inhibitor set step S2). The rust inhibitor set step S2 may be executed after the gas turbine GT is stopped and before the installation step SI of the dry air system 50 described above.

Next, the water stop valve 42 of the cleaning water system 40 is closed, the air stop valve 43 of the cleaning water system 40 is opened, and the compressed air is supplied from the air supply source 55 into the intake casing 15 via the dry air system 50 (dry air supply step S3). In the dry air supply step S3, dust or the like in the compressed air from the air supply source 55 is removed by the filter 52 of the dry air system 50. In addition, a part of the moisture in the compressed air is removed by the dehumidifier 53 (dehumidification step S4). The dry air, which is the compressed air from which the moisture has been removed, is injected into the intake casing 15 via the air stop valve 43 of the cleaning water system 40, a part of the connection line 41c, a part of the cleaning water main line 41m, the plurality of cleaning water branch lines 41b, and the plurality of nozzles 44.

The air inside the gas turbine GT is drawn to the stack 39 side even in a state where the gas turbine rotor 1 is not rotating, due to a draft effect of the stack 39 connected to the gas turbine GT.

For this reason, the dry air supplied into the intake casing 15 flows into the intermediate casing 25 through the inside of the compressor casing 12. The dry air flowed into the intermediate casing 25 is exhausted from the gas turbine GT through the combustor 20, the turbine casing 32, and the exhaust casing 35. In this way, the dry air flows over almost the entire gas turbine GT, and thus the occurrence of rust inside the gas turbine GT, particularly inside the compressor casing 12, can be suppressed.

In addition, the rust-inhibiting component vaporized from the rust inhibitor 54 disposed in the intake casing 15 flows in the gas turbine GT by the dry air. In this process, the rust-inhibiting component adheres to an inner peripheral surface of the compressor casing 12, an outer peripheral surface of the compressor rotor shaft 11s, an outer peripheral surface of the rotor blade, an outer peripheral surface of the stator blade, and an outer peripheral surface of the inlet guide blade 14v, and suppresses the occurrence of rust on these surfaces.

As shown in FIG. 3, the above-described dry air supply step S3 is continuously executed until immediately before the gas turbine GT is reactivated.

Dust or the like contained in the air that has passed through the air intake duct 18 and the intake casing 15 is likely to adhere to a portion in the compressor casing 12 on the axial upstream side Dau. For this reason, the cleaning water system 40 is provided to remove dust or the like adhered to a portion in the compressor casing 12 on the axial upstream side Dau. Specifically, dust or the like contained in the air that has passed through the air intake duct 18 and the intake casing 15 is likely to adhere to the compressor rotor blade rows 11b and the compressor stator blade rows 13 on the axial upstream side Dau. Therefore, it is desirable that the cleaning water system 40 is provided so as to be able to intensively clean the compressor rotor blade rows 11b and the compressor stator blade rows 13 on the axial upstream side Dau. The portion on the axial upstream side Dau in the compressor casing 12 is cleaned by the water from the cleaning water system 40. In this cleaning, the air stop valve 43 of the cleaning water system 40 is closed, the water stop valve 42 is opened, and the water from the water supply source 45 is injected from the plurality of nozzles 44 toward the axial downstream side Dad. It is preferable that the cleaning is performed after the gas turbine GT is stopped and before the rust inhibitor set step S2.

After the end of the dry air supply step S3 and before the start of the activation of the gas turbine GT, the removal step S5 of the dry air system 50 and the rust inhibitor removal step S6 are executed. In the removal step S5 of the dry air system 50 and the rust inhibitor removal step S6, any step may be executed first.

As described above, in the present embodiment, during the stop of the gas turbine GT, the dry air flows through almost the entire gas turbine GT, and the rust-inhibiting component vaporized from the rust inhibitor 54 flows through the gas turbine GT and adheres to the inside of the gas turbine GT. Therefore, it is possible to suppress the occurrence of rust inside the gas turbine GT, particularly inside the compressor casing 12.

In the present embodiment, as described above, the dry air from the dry air system 50 is supplied into the intake casing 15 via a part of the cleaning water system 40. That is, in the present embodiment, a portion that injects a fluid into the intake casing 15 is shared between the cleaning water system 40 and the dry air system 50. Therefore, in the present embodiment, the facility cost can be suppressed. In addition, since the nozzle 44 that injects the cleaning water also serves as a nozzle that injects the dry air into the intake casing 15, the number of nozzles 44 disposed in the intake casing 15 is reduced, and the resistance of the air flowing inside the intake casing 15 can be suppressed.

In the present embodiment, the rust inhibitor 54 is disposed in the intake casing 15. However, the rust inhibitor 54 may be disposed in the air line 51 of the dry air system 50. In this case, since the dry air system 50 has the rust inhibitor 54, it is not necessary to separately execute the rust inhibitor set step S2 and the rust inhibitor removal step S6.

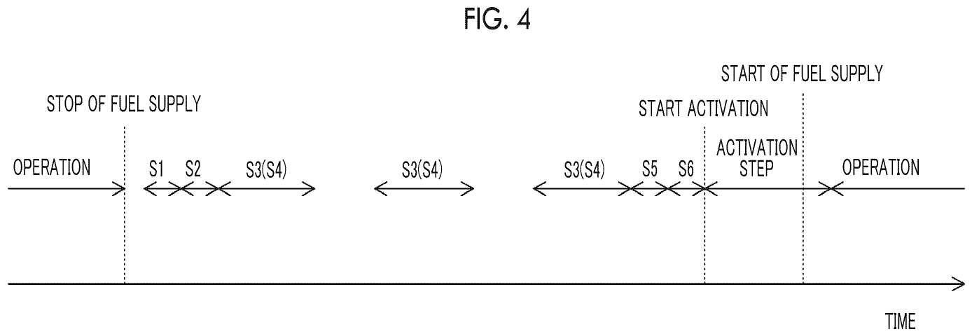

In addition, in the present embodiment, the dry air supply step S3 is continuously executed from the stop of the gas turbine GT to the start of the activation of the gas turbine GT. However, as shown in FIG. 4, the dry air supply step S3 may be intermittently executed multiple times from the stop of the gas turbine GT to the start of the activation of the gas turbine GT.

### Second Embodiment

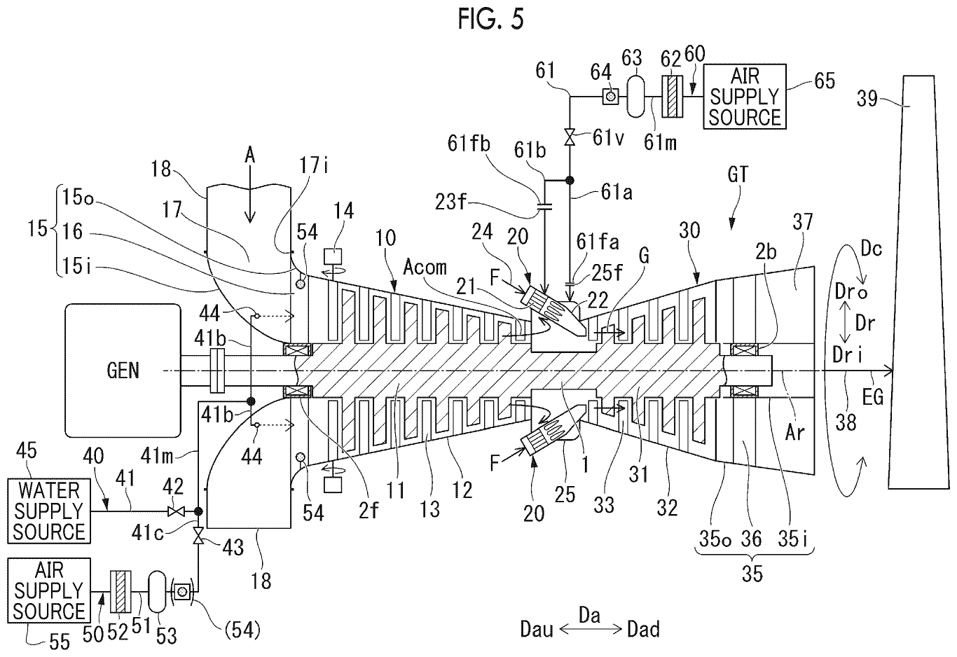

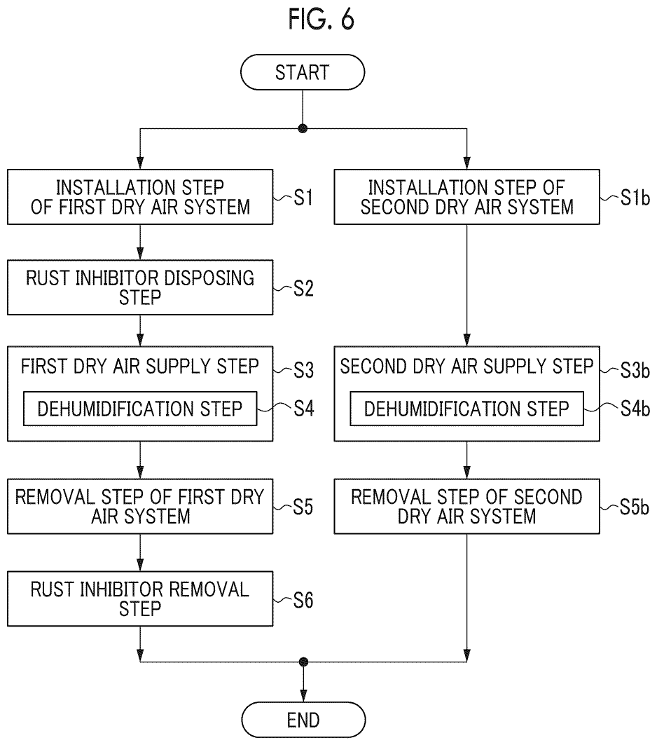

Hereinafter, an embodiment of a rust prevention method for a gas turbine GT and an embodiment of gas turbine equipment capable of executing the rust prevention method in the present embodiment will be described with reference to FIGS. 5 and 6.

As shown in FIG. 5, the gas turbine equipment in the present embodiment includes the gas turbine GT, the air intake duct 18, the air exhaust duct 38, the stack 39, the cleaning water system 40 capable of injecting the cleaning water into the gas turbine GT, and a plurality of rust inhibitors 54, as in the gas turbine equipment in the first embodiment. Further, the gas turbine equipment includes the second dry air system 60 in addition to the first dry air system 50 which is the same as the dry air system 50 in the first embodiment. That is, the gas turbine equipment in the present embodiment is equipment in which the second dry air system 60 is added to the gas turbine equipment in the first embodiment.

The second dry air system 60 is a system capable of supplying dry air into the intermediate casing 25. The second dry air system 60 includes an air line 61 connected to an air supply source 65, a filter 62, a dehumidifier 63, a rust inhibitor 64, and an air stop valve 61v. The air line 61 includes a main air line 61m connected to an air supply source 65, a first air line 61a connected to the main air line 61m and connected to the intermediate casing 25, and a second air line 61b connected to the main air line 61m and connected to the burner 21 of the combustor 20. The filter 62, the dehumidifier 63, the rust inhibitor 64, and the air stop valve 61v are all provided in the main air line 61m. The air supply source 65 of the second dry air system 60 may be the same as or different from the air supply source 55 of the first dry air system 50. The intermediate casing 25 is provided with a casing-side connection flange 25f for connecting to the first air line 61a, and an end of the first air line 61a is provided with a first air line-side connection flange 61fa that can be connected to the casing-side connection flange 25f. The first air line 61a is connected to the intermediate casing 25 by connecting the casing-side connection flange 25f and the first air line-side connection flange 61fa. In addition, the combustor 20 is provided with a combustor-side connection flange 23f for connecting the burner 21 and the second air line 61b, and the end of the second air line 61b is provided with a second air line-side connection flange 61fb that can be connected to the combustor-side connection flange 23f. The second air line 61b is connected to the burner 21 by connecting the casing-side connection flange 25f and the second air line-side connection flange 61fb.

Next, a rust prevention method for the gas turbine GT in the present embodiment will be described with reference to a flowchart shown in FIG. 6.

In the rust prevention method in the present embodiment, the same steps as the steps of the rust prevention method in the first embodiment are also executed. That is, in the present embodiment, the installation step S1 of the first dry air system 50 which is the same as the installation step S1 of the dry air system 50 in the first embodiment, the rust inhibitor set step S2 which is the same as the rust inhibitor set step S2 in the first embodiment, the first dry air supply step S3 which is the same as the dry air supply step S3 in the first embodiment, the removal step S5 of the first dry air system 50 which is the same as the removal step S5 of the dry air system 50 in the first embodiment, and the rust inhibitor removal step S6 which is the same as the rust inhibitor removal step S6 in the first embodiment are executed.

Further, in the rust prevention method in the present embodiment, the installation step Slb of the second dry air system 60, the second dry air supply step S3b, and the removal step S5b of the second dry air system 60 are executed.

The installation step Sib of the second dry air system 60 is executed in parallel with the installation step S1 of the first dry air system 50 or before and after the installation step S1 of the first dry air system 50. In the installation step S1b of the second dry air system 60, the second dry air system 60 prepared in advance is disposed near the intermediate casing 25, and the first air line-side connection flange 61fa of the second dry air system 60 is connected to the casing-side connection flange 25f of the intermediate casing 25. Further, the second air line-side connection flange 61fb of the second dry air system 60 is connected to the combustor-side connection flange 23f of the combustor 20. In addition, in a pre-stage of the installation step SIb of the second dry air system 60, a blind flange is connected to the casing-side connection flange 25f of the intermediate casing 25 and the combustor-side connection flange 23f of the combustor 20. For this reason, after the blind flanges are removed, the first air line-side connection flange 61fa is connected to the casing-side connection flange 25f, and the second air line-side connection flange 61fb is connected to the combustor-side connection flange 23f.

The second dry air supply step S3b is executed in parallel with the first dry air supply step S3. In the second dry air supply step S3b, the air supply source 65 supplies the compressed air into the intermediate casing 25 via the second dry air system 60 by opening the air stop valve 61v of the second dry air system 60. Dust or the like in the compressed air from the air supply source 65 is removed by the filter 62 of the second dry air system 60. In addition, a part of the moisture in the compressed air is removed by the dehumidifier 63 (dehumidification step S4b). The dry air, which is the compressed air from which the moisture is removed, is mixed with the rust-inhibiting component vaporized from the rust inhibitor 64 provided in the air line 61. A part of the dry air mixed with the rust-inhibiting component is injected into the intermediate casing 25 via the first air line 61a. In addition, the other part of the dry air mixed with the rust-inhibiting component is injected into the burner 21 via the second air line 61b.

The dry air injected into the intermediate casing 25 from the second dry air system 60 flows into the combustor 20 together with the dry air injected from the first dry air system 50 and flowing into the intermediate casing 25 via the compressor casing 12. Further, the dry air injected into the burner 21 flows into the transition piece 22 of the combustor 20 together with the dry air flowing into the combustor 20 from the intermediate casing 25. Then, the dry air is exhausted from the gas turbine GT through the turbine casing 32 and the exhaust casing 35.

The dry air injected from the first dry air system 50 may be moistened by the moisture in the compressor casing 12 in the process of passing through the compressor casing 12. In addition, most of the rust-inhibiting component from the rust inhibitor 54 in the intake casing 15 adheres to the blades or the like in the compressor casing 12. In the present embodiment, as described above, the dry air containing the rust-inhibiting component is injected from the second dry air system 60 into the intermediate casing 25 and into the burner 21 of the combustor 20. Therefore, it is possible to suppress the occurrence of rust in the discharge side portion in the compressor casing 12, in the intermediate casing 25, and further in the combustor 20, compared to the first embodiment.

The above-described second dry air supply step S3b is also continuously executed until immediately before the gas turbine GT is reactivated, as in the first dry air supply step S3. As described with reference to FIG. 4, the first dry air supply step S3 and the second dry air supply step S3b may be intermittently executed multiple times.

When the second dry air supply step S3b is ended, the removal step S5b of the second dry air system 60 is executed in parallel with the removal step S5 of the first dry air system 50 or before and after the removal step S5 of the first dry air system 50. At the end of the removal step S5b of the second dry air system 60, a blind flange is connected to the casing-side connection flange 25f of the intermediate casing 25.

### Modification Example

In a case where the amount of dust or the like in the compressed air from the air supply sources 55 and 65 is extremely small, that is, in a case where the dust or the like in the air has already been removed, the filter 52 of the dry air system 50 in the first embodiment and the filter 52 of the first dry air system 50 and the filter 62 of the second dry air system 60 in the second embodiment may be omitted.

In a case where the moisture in the compressed air from the air supply sources 55 and 65 is extremely small, that is, in a case where the moisture in the air has already been removed, the dehumidifier 53 of the dry air system 50 in the first embodiment and the dehumidifier 53 of the first dry air system 50 and the dehumidifier 63 of the second dry air system 60 in the second embodiment may be omitted.

The dry air system 50 in the first embodiment and the first dry air system 50 and the second dry air system 60 in the second embodiment may be permanently installed.

The air line 61 of the dry air system 50 in the first embodiment and the air line 51 of the first dry air system 50 in the second embodiment may be directly connected to the intake casing 15 without passing through the cleaning water system 40.

In addition, the present disclosure is not limited to each of the embodiments described above. Various additions, modifications, substitutions, partial deletions, and the like can be made without departing from the conceptual idea and gist of the present invention derived from the contents defined in the claims and equivalents thereof.

### Supplementary Note

The gas turbine equipment in each of the embodiments described above is understood as follows, for example.

(1) Gas turbine equipment in a first aspect includes: a gas turbine GT; and a dry air system 50 capable of supplying dry air into the gas turbine GT.

The gas turbine GT includes a compressor 10 capable of compressing air A to generate compressed air Acom, a combustor 20 capable of combusting fuel F in the compressed air Acom to generate a combustion gas G, a turbine 30 capable of being driven by the combustion gas G, an intake casing 15, and an intermediate casing 25. The compressor 10 includes a compressor rotor 11 rotatable around an axis Ar, and a compressor casing 12 that covers the compressor rotor 11. The turbine 30 is disposed on the axial downstream side Dad out of the axial upstream side Dau and the axial downstream side Dad in the axial direction Da in which the axis Ar extends with respect to the compressor 10. The turbine 30 includes a turbine rotor 31 connected to the compressor rotor 11 and is rotatable around the axis Ar, and a turbine casing 32 that covers the turbine rotor 31. The intake casing 15 is connected to an end of the compressor casing 12 on the axial upstream side Dau such that air is guided into the compressor casing 12. The intermediate casing 25 is disposed between the compressor casing 12 and the turbine casing 32 in the axial direction Da, is connected to an end of the compressor casing 12 on the axial downstream side Dad such that the compressed air Acom from the compressor 10 is capable of flowing in, and is connected to an end of the turbine casing 32 on the axial upstream side Dau. The combustor 20 is attached to the intermediate casing 25 such that the compressed air Acom in the intermediate casing 25 is capable of flowing into the combustor 20 and the combustion gas G is capable of being sent into the turbine casing 32. The combustor 20 includes a burner 21 capable of injecting the fuel F together with the compressed air Acom, and a transition piece (or combustion tube) 22 in which the fuel F injected from the burner 21 is capable of being combusted in the compressed air Acom. The dry air system 50 includes an air line 51 through which air from an air supply source 55 is capable of flowing, and is configured to supply the air flowing through the air line 51 into the intake casing 15 as the dry air.

In the present aspect, during the stop of the gas turbine GT, the dry air from the dry air system 50 is supplied into the intake casing 15. Basically, a stack 39 for discharging exhaust gas from the gas turbine GT is provided on the exhaust side of the gas turbine GT. For this reason, the air inside the gas turbine GT is drawn to the stack 39 side even in a state where the gas turbine rotor 1 is not rotating, due to the draft effect of the stack 39. Therefore, the dry air supplied into the intake casing 15 flows into the intermediate casing 25 through the inside of the compressor casing 12. The dry air that has flowed into the intermediate casing 25 is exhausted from the gas turbine GT through the combustor 20 and the turbine casing 32. In this way, the dry air flows over almost the entire gas turbine GT, and thus the occurrence of rust inside the gas turbine GT, particularly inside the compressor casing 12, can be suppressed.

(2) In the gas turbine equipment in a second aspect, the gas turbine equipment in the first aspect further includes the cleaning water system 40 capable of injecting water from an inside of the intake casing 15 to an inside of the compressor casing 12.

The cleaning water system 40 includes a cleaning water line 41 extending from the water supply source 45 to the inside of the intake casing 15, and a nozzle 44 attached to an end of the cleaning water line 41 in the intake casing 15 and capable of injecting water toward the axial downstream side Dad. The air line 51 is connected to the cleaning water line 41.

In the present aspect, a portion that injects a fluid in the intake casing 15 is shared between the cleaning water system 40 and the dry air system 50. Therefore, in the present aspect, it is possible to suppress an increase in facility cost. In addition, the number of portions that inject the fluid in the intake casing 15 is reduced, and the resistance of the air flowing in the intake casing 15 can be suppressed.

(3) In the gas turbine equipment in a third aspect, in the gas turbine equipment in the first aspect or the second aspect, the dry air system 50 includes a dehumidifier 53 capable of removing moisture in the air.

The dehumidifier 53 is provided in the air line 51.

In the present aspect, the moisture in the air supplied into the intake casing 15 can be reduced.

(4) In the gas turbine equipment in a fourth aspect, the gas turbine equipment according to any one of the first aspect to the third aspect further includes a vaporizable rust inhibitor 54 disposed in the air line 51 or in the intake casing 15.

In the present aspect, the rust-inhibiting component vaporized from the rust inhibitor 54 flows from the intake casing 15 into the compressor casing 12 together with the dry air. For this reason, the rust-inhibiting component can adhere to the members in the intake casing 15 or in the compressor casing 12, and thus it is possible to suppress the occurrence of rust on the members.

(5) In the gas turbine equipment in a fifth aspect, the gas turbine equipment in any one of the first to fourth aspects further includes the second dry air system 60 capable of supplying the dry air into the intermediate casing 25, in addition to the first dry air system 50 as the dry air system 50.

The second dry air system 60 includes an air line 61 that connects the air supply source 65 and the intermediate casing 25 such that the air from the air supply source 65 is guided into the intermediate casing 25.

In the present aspect, the dry air is injected from the second dry air system 60 into the intermediate casing 25.

The dry air is exhausted from the gas turbine GT through the combustor 20 and the turbine casing 32 together with the dry air that has been injected from the first dry air system 50 and has flowed into the intermediate casing 25 via the compressor casing 12.

The dry air injected from the first dry air system 50 may be moistened by the moisture in the compressor casing 12 in the process of passing through the compressor casing 12. In the present aspect, as described above, the dry air is injected from the second dry air system 60 into the intermediate casing 25. Therefore, in the present aspect, it is possible to suppress the occurrence of rust in the discharge side portion in the compressor casing 12, in the intermediate casing 25, and further in the combustor 20.

(6) In the gas turbine equipment in a sixth aspect, in the gas turbine equipment in the fifth aspect, the air line 61 of the second dry air system 60 includes a main air line 61m connected to the air supply source 65, a first air line 61a connected to the main air line 61m and connected to the intermediate casing 25, and a second air line 61b connected to the main air line 61m and connected to the burner 21 of the combustor 20.

In the present aspect, the dry air can be injected into the burner 21 of the combustor 20.

(7) In the gas turbine equipment in a seventh aspect, in the gas turbine equipment in the fifth aspect or the sixth aspect, the second dry air system 60 includes a dehumidifier 63 capable of removing moisture in the air.

The dehumidifier 63 of the second dry air system 60 is provided in the air line 61 of the second dry air system 60.

In the present aspect, the moisture in the air supplied from the second dry air system 60 into the intermediate casing 25 can be reduced.

(8) In the gas turbine equipment in an eighth aspect, in the gas turbine equipment in any one of the fifth to seventh aspects, the second dry air system 60 includes a vaporizable rust inhibitor 64 disposed in the air line 61 of the second dry air system 60.

In the present aspect, the rust-inhibiting component vaporized from the rust inhibitor 64 is supplied into the intermediate casing 25 together with the dry air. The rust-inhibiting component flows from the intermediate casing 25 to the combustor 20 and the turbine casing 32 together with the dry air. For this reason, the rust-inhibiting component adheres to the member on the discharge side portion of the compressor casing 12, the member inside the intermediate casing 25, and the member inside the combustor 20, and thus it is possible to suppress the occurrence of rust on these members.

The rust prevention method for the gas turbine GT in each of the above-described embodiments is understood as follows, for example.

(9) A rust prevention method for a gas turbine in a ninth aspect is applied to the following gas turbine.

The gas turbine GT includes a compressor 10 capable of compressing air A to generate compressed air Acom, a combustor 20 capable of combusting fuel F in the compressed air Acom to generate a combustion gas G, a turbine 30 capable of being driven by the combustion gas G, an intake casing 15, and an intermediate casing 25. The compressor 10 includes a compressor rotor 11 rotatable around an axis Ar, and a compressor casing 12 that covers the compressor rotor 11. The turbine 30 is disposed on the axial downstream side Dad out of the axial upstream side Dau and the axial downstream side Dad in the axial direction Da in which the axis Ar extends with respect to the compressor 10, The turbine 30 includes a turbine rotor 31 connected to the compressor rotor 11 and is rotatable around the axis Ar, and a turbine casing 32 that covers the turbine rotor 31. The intake casing 15 is connected to an end of the compressor casing 12 on the axial upstream side Dau such that air is guided into the compressor casing 12. The intermediate casing 25 is disposed between the compressor casing 12 and the turbine casing 32 in the axial direction Da, is connected to an end of the compressor casing 12 on the axial downstream side Dad such that the compressed air Acom from the compressor 10 is capable of flowing in, and is connected to an end of the turbine casing 32 on the axial upstream side Dau. The combustor 20 is attached to the intermediate casing 25 such that the compressed air Acom in the intermediate casing 25 is capable of flowing into the combustor 20 and the combustion gas G is capable of being sent into the turbine casing 32. The combustor 20 includes a burner 21 capable of injecting the fuel F together with the compressed air Acom, and a transition piece (or combustion tube) 22 in which the fuel F injected from the burner 21 is capable of being combusted in the compressed air Acom.

In this rust prevention method for a gas turbine GT, a dry air supply step S3 of supplying dry air into the intake casing 15 is executed during stop of the gas turbine GT.

In the present aspect, as in the first aspect of the gas turbine equipment, it is possible to suppress the occurrence of rust inside the gas turbine GT, particularly inside the compressor casing 12.

(10) In a rust prevention method for a gas turbine in a tenth aspect, in the rust prevention method for the gas turbine GT in the ninth aspect, a cleaning water system 40 that injects water from the inside of the intake casing 15 to an inside of the compressor casing 12 is connected to the intake casing 15.

The cleaning water system 40 includes a cleaning water line 41 extending from the water supply source 45 to the inside of the intake casing 15, and a nozzle 44 attached to an end of the cleaning water line 41 in the intake casing 15 and capable of injecting water toward the axial downstream side Dad. In the dry air supply step S3, the dry air is sent into the cleaning water line 41, and the dry air is supplied into the intake casing 15 via the cleaning water line 41 and the nozzle 44.

In the present aspect, as in the second aspect of the gas turbine equipment, it is possible to suppress an increase in facility cost and to suppress resistance of air flowing inside the intake casing 15.

(11) In the rust prevention method for a gas turbine in an eleventh aspect, in the rust prevention method for the gas turbine GT in the ninth aspect or the tenth aspect, the dry air supply step S3 includes a dehumidification step S4 of removing moisture in the air to be sent into the intake casing 15 to generate the dry air.

In the present aspect, as in the third aspect of the gas turbine equipment, the moisture in the air supplied into the intake casing 15 can be reduced.

(12) In the rust prevention method for a gas turbine in a twelfth aspect, in the rust prevention method for the gas turbine GT according to any one of the ninth to eleventh aspects, a rust inhibitor set step S2 of disposing the vaporizable rust inhibitor 54 in the intake casing 15 after the gas turbine GT is stopped and before the dry air supply step S3 is executed.

In the present aspect, as in the fourth aspect of the gas turbine equipment, the rust-inhibiting component can adhere to the members in the intake casing 15 or in the compressor casing 12, and thus it is possible to suppress the occurrence of rust on the members.

(13) In a rust prevention method for a gas turbine according to a thirteenth aspect, in the rust prevention method for the gas turbine GT according to any one of the ninth to twelfth aspects, the rust prevention method executes a second dry air supply step S3b of supplying dry air into the intermediate casing 25, in addition to a first dry air supply step S3 as the dry air supply step S3.

In the present aspect, as in the fifth aspect of the gas turbine equipment, it is possible to suppress the occurrence of rust in the discharge side portion in the compressor casing 12, in the intermediate casing 25, and further in the combustor 20.

(14) In the rust prevention method for a gas turbine in a fourteenth aspect, in the rust prevention method for the gas turbine GT in the thirteenth aspect, in the second dry air supply step S3b, the dry air is supplied to the burner 21 of the combustor 20.

(15) In the rust prevention method for a gas turbine in a fifteenth aspect, in the rust prevention method for the gas turbine GT in the thirteenth aspect or the fourteenth aspect, the second dry air supply step S3b includes a dehumidification step S4b of removing moisture in the air to be sent into the intermediate casing 25 to generate the dry air.

In the present aspect, as in the seventh aspect of the gas turbine equipment, the moisture in the air supplied from the second dry air system 60 into the intermediate casing 25 can be reduced.

### Industrial Applicability

According to one aspect of the present disclosure, it is possible to suppress the occurrence of rust in the gas turbine.

### REFERENCE SIGNS LIST

GT: gas turbine
1: gas turbine rotor
2f: front bearing
2b: rear bearing
10: compressor
11: compressor rotor
11s: compressor rotor shaft
11b: compressor rotor blade row
12: compressor casing
13: compressor stator blade row
14: intake air amount regulator
14v: inlet guide blade
14d: driver
15: intake casing
15i: intake inner casing
15o: intake outer casing
16: intake strut
17: air passage
17i: intake port
18: air intake duct
20: combustor
21: burner
22: transition piece (or combustion tube)
23f: combustor-side connection flange
24: fuel line
25: intermediate casing
25f: casing-side connection flange
30: turbine
31: turbine rotor
31s: turbine rotor shaft
31b: turbine rotor blade row
32: turbine casing
33: turbine stator blade row
35: exhaust casing
35i: exhaust inner casing
35o: exhaust outer casing
36: exhaust strut
37: exhaust passage
38: air exhaust duct
39: stack
40: cleaning water system
41: cleaning water line
41m: cleaning water main line
41c: connection line
41b: cleaning water branch line
42: water stop valve
43: air stop valve
44: nozzle
45: water supply source
50: dry air system or first dry air system
51: air line
52: filter
53: dehumidifier
54: rust inhibitor
55: air supply source
60: second dry air system
61: air line
61m: main air line
61a: first air line
61b: second air line
61fa: first air line-side connection flange
61fb: second air line-side connection flange
61v: air stop valve
62: filter
63: dehumidifier
64: rust inhibitor
65: air supply source
A: air
Acom: compressed air
F: fuel
G: combustion gas
EG: exhaust gas
Ar: axis
Da: axial direction
Dau: axial upstream side
Dad: axial downstream side
Dc: circumferential direction
Dr: radial direction
Dri: radial inner side
Dro: radial outer side

1. Gas turbine equipment comprising:
a gas turbine; and
a dry air system capable of supplying dry air into the gas turbine,
wherein the gas turbine includes a compressor capable of compressing air to generate compressed air, a combustor capable of combusting fuel in the compressed air to generate a combustion gas, a turbine capable of being driven by the combustion gas, an intake casing, and an intermediate casing,
the compressor includes a compressor rotor rotatable around an axis, and a compressor casing that covers the compressor rotor,
the turbine is disposed on an axial downstream side out of an axial upstream side and the axial downstream side in an axial direction in which the axis extends with respect to the compressor,
the turbine includes a turbine rotor connected to the compressor rotor and rotatable around the axis, and a turbine casing that covers the turbine rotor,
the intake casing is connected to an end of the compressor casing on the axial upstream side such that air is guided into the compressor casing,
the intermediate casing is disposed between the compressor casing and the turbine casing in the axial direction, is connected to an end of the compressor casing on the axial downstream side such that the compressed air from the compressor is capable of flowing in, and is connected to an end of the turbine casing on the axial upstream side,
the combustor is attached to the intermediate casing such that the compressed air in the intermediate casing is capable of flowing into the combustor and the combustion gas is capable of being sent into the turbine casing,
the combustor includes a burner capable of injecting fuel together with the compressed air, and a transition piece in which the fuel injected from the burner is capable of being combusted in the compressed air, and
the dry air system includes an air line through which air from an air supply source is capable of flowing, and is configured to supply the air flowing through the air line into the intake casing as the dry air.

2. The gas turbine equipment according to claim 1, further comprising:
a cleaning water system capable of injecting water from an inside of the intake casing to an inside of the compressor casing,
wherein the cleaning water system includes a cleaning water line extending from a water supply source to the inside of the intake casing, and a nozzle attached to an end of the cleaning water line in the intake casing and capable of injecting water toward the axial downstream side, and
the air line is connected to the cleaning water line.

3. The gas turbine equipment according to claim 1,
wherein the dry air system includes a dehumidifier capable of removing moisture in the air, and
the dehumidifier is provided in the air line.

4. The gas turbine equipment according to claim 1, further comprising:
a vaporizable rust inhibitor disposed in the air line or in the intake casing.

5. The gas turbine equipment according to claim 1, further comprising:
a second dry air system capable of supplying dry air into the intermediate casing, in addition to a first dry air system as the dry air system,
wherein the second dry air system includes an air line that connects the air supply source and the intermediate casing such that the air from the air supply source is guided into the intermediate casing.

6. The gas turbine equipment according to claim 5,
wherein the air line of the second dry air system includes a main air line connected to the air supply source, a first air line connected to the main air line and connected to the intermediate casing, and a second air line connected to the main air line and connected to the burner of the combustor.

7. The gas turbine equipment according to claim 5,
wherein the second dry air system includes a dehumidifier capable of removing moisture in the air, and
the dehumidifier of the second dry air system is provided in the air line of the second dry air system.

8. The gas turbine equipment according to claim 5,
wherein the second dry air system includes a vaporizable rust inhibitor disposed in the air line of the second dry air system.

9. A rust prevention method for a gas turbine including a compressor capable of compressing air to generate compressed air, a combustor capable of combusting fuel in the compressed air to generate a combustion gas, a turbine capable of being driven by the combustion gas, an intake casing, and an intermediate casing,
in which the compressor includes a compressor rotor rotatable around an axis, and a compressor casing that covers the compressor rotor,
the turbine is disposed on an axial downstream side out of an axial upstream side and the axial downstream side in an axial direction in which the axis extends with respect to the compressor,
the turbine includes a turbine rotor connected to the compressor rotor and rotatable around the axis, and a turbine casing that covers the turbine rotor,
the intake casing is connected to an end of the compressor casing on the axial upstream side such that air is guided into the compressor casing,
the intermediate casing is disposed between the compressor casing and the turbine casing in the axial direction, is connected to an end of the compressor casing on the axial downstream side such that the compressed air from the compressor is capable of flowing in, and is connected to an end of the turbine casing on the axial upstream side,
the combustor is attached to the intermediate casing such that the compressed air in the intermediate casing is capable of flowing into the combustor and the combustion gas is capable of being sent into the turbine casing, and
the combustor includes a burner capable of injecting fuel together with the compressed air, and a transition piece in which the fuel injected from the burner is capable of being combusted in the compressed air,
the rust prevention method comprising:
executing a dry air supply step of supplying dry air into the intake casing during stop of the gas turbine.

10. The rust prevention method for a gas turbine according to claim 9,
wherein a cleaning water system that injects water from an inside of the intake casing to an inside of the compressor casing is connected to the intake casing,
the cleaning water system includes a cleaning water line extending from a water supply source to the inside of the intake casing, and a nozzle attached to an end of the cleaning water line in the intake casing and capable of injecting water toward the axial downstream side, and
in the dry air supply step, the dry air is sent into the cleaning water line, and the dry air is supplied into the intake casing via the cleaning water line and the nozzle.

11. The rust prevention method for a gas turbine according to claim 9,
wherein the dry air supply step includes a dehumidification step of removing moisture in the air to be sent into the intake casing to generate the dry air.

12. The rust prevention method for a gas turbine according to claim 9, further comprising:
a rust inhibitor set step of disposing a vaporizable rust inhibitor in the intake casing after the gas turbine is stopped and before the dry air supply step is executed.

13. The rust prevention method for a gas turbine according to claim 9, further comprising:
executing a second dry air supply step of supplying dry air into the intermediate casing, in addition to a first dry air supply step as the dry air supply step.

14. The rust prevention method for a gas turbine according to claim 13,
wherein in the second dry air supply step, the dry air is supplied to the burner of the combustor.

15. The rust prevention method for a gas turbine according to claim 13,
wherein the second dry air supply step includes a dehumidification step of removing moisture in the air to be sent into the intermediate casing to generate the dry air.
